(19) United States
(12) Patent Application Publication
(10) Pub. No.: US 2013/0031161 A1
(43) Pub. Date: Jan. 31, 2013

(54) APPARATUSES AND METHODS FOR UNIFIED VIRTUAL EXPERIENCE (UVE) SESSION CONTROL

(71) Applicant: Ju-Ting YANG, Taoyuan City (TW)

(72) Inventor: Ju-Ting YANG, Taoyuan City (TW)

(73) Assignee: HTC CORPORATION, Taoyuan City (TW)

(21) Appl. No.: 13/557,029

(22) Filed: Jul. 24, 2012

Related U.S. Application Data
(60) Provisional application No. 61/511,569, filed on Jul. 26, 2011.

(51) Int. Cl. G06F 15/16

(52) U.S. Cl. 709/203

(57) ABSTRACT

A client-initiated session control method for Unified Virtual Experience (UVE) is provided. The client-initiated session control method includes the steps of transmitting, by one of a plurality of UVE clients in an ongoing application session, a first Suspension Request message to a UVE server for suspending the ongoing application session, receiving, by each of the UVE clients, a respective second Suspension Request message from the UVE server in response to the first Suspension Request message, and suspending, by each of the UVE clients, the ongoing application session in response to the second Suspension Request message.

### CROSS REFERENCE TO RELATED APPLICATIONS

This Application claims priority of U.S. Provisional Application No. 61/511,569, filed on Jul. 26, 2011, and the entirety of which is incorporated by reference herein.

### BACKGROUND OF THE INVENTION

1. Field of the Invention

The invention generally relates to session control for Unified Virtual Experience (UVE), and more particularly, to suspension and resumption of an ongoing application session between a UVE server and multiple UVE clients.

2. Description of the Related Art

With the advancement of high profile applications (e.g online games) and various available platforms, such as iOS4, Android, Windows Mobile, Symbian, etc., the service consumption is becoming more and more complex and difficult. Not to mention that the number of electronic devices available with different hardware and software specifications is making things more complicated. As an application is generally developed for a particular platform with strict hardware and software requirements, the described constraints have proved to be a hurdle for the complete value chain. For example, users/clients can only use applications which are compliant to their device hardware and software platform specifications, content providers have to create multiple versions of the application depending on which hardware and software platform they want them to execute on, and service providers can't do much to help their subscribers despite knowing about this inconvenience of their users and partnered content providers.

The Open Mobile Alliance (OMA) was formed in June 2002 by nearly 200 companies representing the world's leading corporations in various fields of the mobile industry, including mobile operators, device and network suppliers, information technology companies, and content/service providers, with an aim to develop open standards for providing interoperable service enablers working across countries, operators and mobile devices in the mobile phone industry. The OMA Unified Virtual Experience (UVE) is the international de facto standard for attempting to solve the above described problems by optimizing the current application usage model in which a unified platform (cloud computing platform) is provided to host various applications and enable different content and services in the cloud, and to provide them to the users/clients using virtualization techniques (cloud computing), as shown in FIG. 1. As the application may be run irrespective of the platform used on the user device, a better user experience may be achieved.

### BRIEF SUMMARY OF THE INVENTION

In a first aspect of the invention, a client-initiated session control method for Unified Virtual Experience (UVE) is provided. The client-initiated session control method comprises the steps of transmitting, by one of a plurality of UVE clients in an ongoing application session, a first Suspension Request message to a UVE server for suspending the ongoing application session, receiving, by each of the UVE clients, a respective second Suspension Request message from the UVE server in response the first Suspension Request message, and suspending, by each of the UVE clients, the ongoing application session in response to the second Suspension Request message.

In a second aspect of the invention, an electronic device, configured as one of a plurality of UVE clients in an ongoing application session with a UVE server is provided. The electronic device comprises first processor logic, second processor logic, and third processor logic. The first processor logic is configured for transmitting a first Suspension Request message to the UVE server for suspending the ongoing application session. The second processor logic is configured for receiving a respective second Suspension Request message for each of the UVE clients from the UVE server. The third processor logic is configured for suspending the ongoing application session in response to the second Suspension Request message.

In a third aspect of the invention, a server-initiated session control method for UVE is provided. The server-initiated session control method comprises the steps of transmitting, by a UVE server, a respective Suspension Request message to each of a plurality of UVE clients in an ongoing application session for suspending the ongoing application session, and suspending, by each of the UVE clients, the ongoing application session in response to the Suspension Request message.

In a fourth aspect of the invention, an electronic device configured as a UVE server is provided. The electronic device comprises first processor logic. The first processor logic is configured for transmitting a respective Suspension Request message to each of a plurality of UVE clients in an ongoing application session for suspending the ongoing application session, so that each of the UVE clients suspends the ongoing application session in response to the Suspension Request message.

In a fifth aspect of the invention, a client-initiated session control method for UVE is provided. The method comprises the steps of transmitting, by one of a plurality of UVE clients in a suspended application session, a first Resumption Request message to a UVE server for resuming the suspended application session, receiving, by each of the UVE clients, a respective second Resumption Request message from the UVE server in response to the first Resumption Request message, resuming, by each of the UVE clients, the suspended application session in response to the first Resumption Request message, and transmitting, by each of the UVE clients, a respective first Resumption Response message to the UVE server in response to resuming the suspended application session.

In a sixth aspect of the invention, an electronic device configured as one of a plurality of UVE clients in a suspended application session with a UVE server is provided. The electronic device comprises first processor logic, second processor logic, third processor logic, and fourth processor logic. The first processor logic is configured for transmitting a first Resumption Request message to the UVE server for resuming the suspended application session. The second processor logic is configured for receiving a respective second Resumption Request message for each of UVE clients from the UVE server. The third processor logic is configured for resuming the suspended application session in response to the second Resumption Request message. The fourth processor logic is configured for transmitting a first Resumption Response message to the UVE server in response to resuming the suspended application session.

In a seventh aspect of the invention, a server-initiated session control method for UVE is provided. The method comprises the steps of transmitting, by a UVE server, a respective first Resumption Request message to each of a plurality of UVE clients in a suspended application session, resuming, by each of the UVE clients, the suspended application session in response to the first Resumption Request message, and receiving, by the UVE server, a respective first Resumption Response message from each of the UVE clients in response to the suspended application session being resumed.

In an eighth aspect of the invention, an electronic device configured as a UVE server is provided. The electronic device comprises first processor logic and second processor logic. The first processor logic is configured for transmitting a respective first Resumption Request message to each of a plurality of UVE clients in a suspended application session, so that each of the UVE clients resumes the suspended application session. The second processor logic is configured for receiving a respective first Resumption Response message from each of the UVE clients.

Other aspects and features of the present invention will become apparent to those with ordinarily skill in the art upon review of the following descriptions of specific embodiments of electronic devices and client-initiated and server-initiated session control methods for UVE.

### BRIEF DESCRIPTION OF DRAWINGS

The invention can be more fully understood by reading the subsequent detailed description and examples with references made to the accompanying drawings, wherein:

FIG. 1 is a schematic view for Unified Virtual Experience (UVE);

FIG. 2 is a block diagram illustrating a UVE application usage model according to an embodiment of the invention;

FIG. 3 is a message sequence chart illustrating a client-initiated session suspension according to an embodiment of the invention;

FIG. 4 is a message sequence chart illustrating a server-initiated session suspension according to an embodiment of the invention;

FIG. 5 is a message sequence chart illustrating a client-initiated session resumption according to an embodiment of the invention;

FIG. 6 is a message sequence chart illustrating a server-initiated session resumption according to an embodiment of the invention;

FIGS. 7A to 7E show a client-initiated session suspension and resumption according to an embodiment of the invention;

FIG. 8 is a flow chart illustrating the client-initiated session control method for UVE according to an embodiment of the invention;

FIG. 9 is a flow chart illustrating the server-initiated session control method for UVE according to an embodiment of the invention;

FIG. 10 is a flow chart illustrating the client-initiated session control method for UVE according to another embodiment of the invention; and

FIG. 11 is a flow chart illustrating the server-initiated session control method for UVE according to another embodiment of the invention.

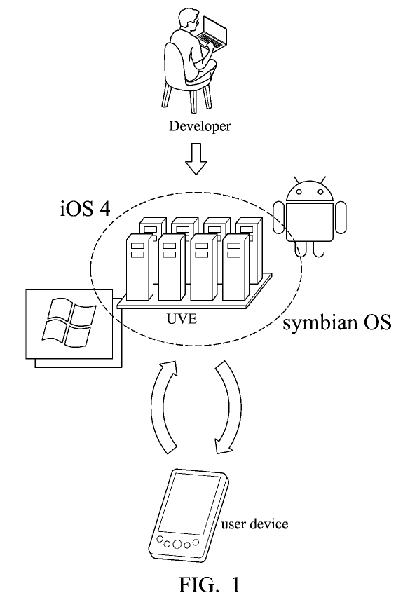

### DETAILED DESCRIPTION OF THE INVENTION

The following description is of the best-contemplated mode of carrying out the invention. This description is made for the purpose of illustrating the general principles of the invention and should not be taken in a limiting sense.

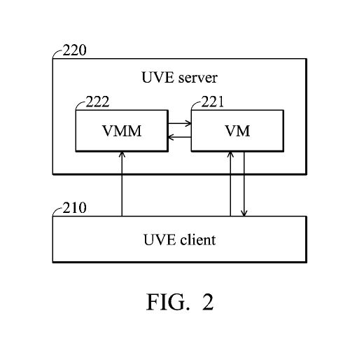

FIG. 2 is a block diagram illustrating a UVE application usage model according to an embodiment of the invention. In the UVE application usage model, the UVE client 210 is a logical entity in the user terminal for communicating with the UVE server 220 for enabling UVE enabled services and utilizing virtualization technology to enable underlying operating system agnostic applications. The UVE server 220 is a logical entity for providing unified virtual experience, which comprises two sub-entities: the Virtual Machine (VM) 221 and the Virtual Machine Management (VMM) 222. The VM 221 is logical entity which provides one or more virtual machines to emulate different operating systems for application hosting, output generation, local resource provisioning, interaction execution, UVE application procurement, and user image file deployment and update. The VMM 222 is a logical entity which is responsible for managing the VM 221, selecting virtual machine, watcher management, user image file store/restore, user management, user image file management, UVE application management, and UVE application procurement. For example, the VMM 222 may select a particular one among all virtual machines and assign the virtual machine to serve a UVE client according to the UVE client's capability. Detailed description of the VM 221 and the VMM 222 is omitted herein as it is beyond the scope of the invention, and reference may be made to the OMA UVE specifications. Specifically, the UVE client 210 may be implemented with program code which is enabled when loaded and executed by a general-purpose processor or a Micro-Control Unit (MCU) of the user terminal. Similarly, the UVE server 220 may be implemented with program code, which is enabled when loaded and executed by a general-purpose processor or an MCU of the server device. Note that the general-purpose processors or MCUs of the electronic device and the server device may each comprise processor logic for performing the described tasks for the UVE client 210 and the UVE server 220, and for performing the client-initiated and server-initiated session control methods for UVE as proposed in the invention.

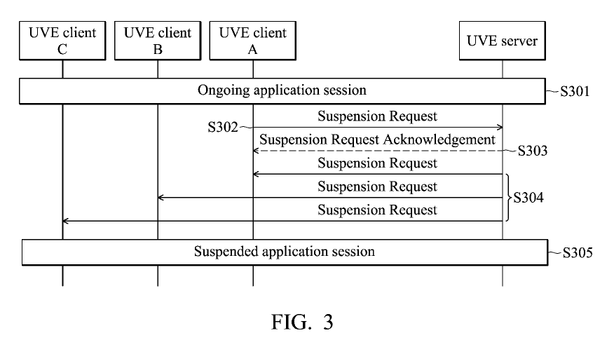

FIG. 3 is a message sequence chart illustrating a client-initiated session suspension according to an embodiment of the invention. To begin, 3 UVE clients A, B, and C start a UVE application session with the UVE server (step S301). Next, the UVE client A initiates a suspension procedure by transmitting a first Suspension Request message to the UVE server for suspending the ongoing application session (step S302). The first Suspension Request message may comprise any combination of a UVE user ID, a UVE session ID, and a cause, wherein the UVE user ID indicates the identification of the initiating UVE client, the UVE session ID indicates the identification of the session to be suspended, and the cause indicates the suspension reason, such as “temporary codec change”, “temporary bandwidth change”, or “temporary pause/shutdown”. In another embodiment, the UVE client A may be involved in more than one UVE application session, and the first Suspension Request message may comprise a UVE session ID List, instead of a UVE session ID, to indicate a list of session identifications, if the UVE client A wishes to suspend more than one UVE application session.

When receiving the first Suspension Request message, the UVE server may transmit a Suspension Request Acknowledgement message to the UVE client A for acknowledging the reception of the first Suspension Request message (step S303). The Suspension Request Acknowledgement message may comprise a status for indicating whether the reception of the first Suspension Request message is successful or failed. In another embodiment, the UVE server may not transmit the Suspension Request Acknowledgement message or any response message to the UVE client A for acknowledging the reception of the first Suspension Request message.

Subsequent to step S303, the UVE server transmits a second Suspension Request message to each of the UVE clients which are in the session indicated by the UVE session ID in the first Suspension Request message (step S304). Each second Suspension Request message may comprise any combination of a UVE user ID List, a UVE session ID, a time for synchronization control, and a cause, wherein the UVE user ID List indicates a list of identifications of the UVE clients intended for this suspension procedure, the UVE session ID indicates the identification of the session to be suspended, the time for synchronization control indicates when the UVE clients should suspend the ongoing application session, and the cause indicates the suspension reason, such as “temporary codec change”, “temporary bandwidth change”, “temporary pause/shutdown”. Specifically, in this embodiment, the cause in the second Suspension Request message should correspond to the cause in the first Suspension Request message, since the suspension procedure is client-initiated in the first place. In another embodiment, the second Suspension Request message may comprise a UVE user ID, instead of a UVE user ID List, to indicate only the receiving UVE client. In yet another embodiment, if the UVE server wishes to suspend more than one UVE application session, the second Suspension Request message may comprise a UVE session ID List, instead of a UVE session ID, to indicate a list of session identifications.

In response to the second Suspension Request message, the UVE clients A, B, and C suspend the ongoing application session (step S305). Specifically, the UVE clients A, B, and C may suspend the ongoing application session according to the second Suspension Request message. For example, the UVE clients A, B, and C may suspend the ongoing application session indicated by the UVE session ID in the second Suspension Request message, and the suspension is performed at the time indicated by the time for synchronization control in the second Suspension Request message.

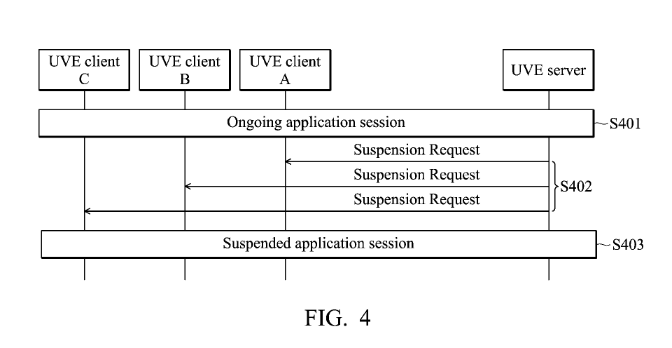

FIG. 4 is a message sequence chart illustrating a server-initiated session suspension according to an embodiment of the invention. Similar to FIG. 3, 3 UVE clients A, B, and C start a UVE application session with the UVE server (step S401). Next, the UVE server initiates a suspension procedure by transmitting a respective Suspension Request message to each of the UVE clients A, B, and C for suspending the ongoing application session (step S402). The Suspension Request message may comprise any combination of a UVE user ID, a UVE session ID, a time for synchronization control, and a cause, wherein the UVE user ID indicates the identification of the initiating UVE client, the UVE session ID indicates the identification of the session to be suspended, the time for synchronization control indicates when the UVE clients should suspend the ongoing application session, and the cause indicates the suspension reason, such as “temporary codec change, “temporary bandwidth change”, “temporary pause/shutdown”, or “temporarily unavailable”. For example, the cause in the Suspension Request message may be set to “temporarily unavailable”, if the UVE server detects a poor air condition, e.g., Signal-to-Interference Ratio (SIR), received signal level, or other RF metrics, associated with a certain UVE client in the ongoing application session, and potential radio link failure, gradual signal drop, and connection loss may be avoided by initiating the suspension procedure. In another embodiment, if the UVE server wishes to suspend more than one UVE application session, the Suspension Request message may comprise a UVE session ID List, instead of a UVE session ID, to indicate a list of session identifications.

In response to the Suspension Request message, the UVE clients A, B, and C suspend the ongoing application session (step S403). Specifically, the UVE clients A, B, and C may suspend the ongoing application session according to the Suspension Request message. For example, the UVE clients A, B, and C may suspend the ongoing application session indicated by the UVE session ID in the Suspension Request message, and the suspension is performed at the time indicated by the time for synchronization control in the Suspension Request message.

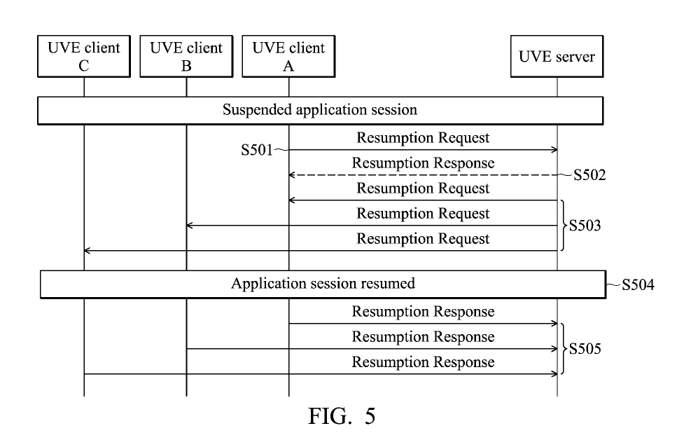

FIG. 5 is a message sequence chart illustrating a client-initiated session resumption according to an embodiment of the invention. In this embodiment, there are 3 UVE clients A, B, and C in a suspended application session with a UVE server, wherein the application session may be suspended as described above with respect to FIG. 4 or 5 or by another suspension mechanism, and the invention is not limited thereto. To begin, when the UVE client A wishes to resume the suspended application session, it initiates a resumption procedure by transmitting a first Resumption Request message to the UVE server for resuming the suspended application session (step S501). The first Resumption Request message may comprise any combination of a UVE user ID, a UVE session ID, and a cause, wherein the UVE user ID indicates the identification of the initiating UVE client, and the UVE session ID indicates the identification of the session to be resumed, and the cause indicates the resumption reason.

When receiving the first Resumption Request message, the UVE server may transmit a first Resumption Response message to the UVE client A for acknowledging the reception of the first Resumption Request message (step S502). The first Resumption Response message may comprise a status for indicating whether the reception of the first Resumption Request message is successful or failed. In another embodiment, the UVE server may not transmit the first Resumption Response message to the UVE client A for acknowledging the reception of the first Resumption Request message.

Next, the UVE server transmits a second Resumption Request message to each of the UVE clients which are in the application session indicated by the UVE session ID in the first Resumption Request message (step S503). The second Resumption Request message may comprise any combination of a UVE user ID List, a UVE session ID, and a time for synchronization control, wherein the UVE user ID List indicates a list of identifications of the UVE clients intended for this resumption procedure, the UVE session ID indicates the identification of the session to be resumed, and the time for synchronization control indicates when the UVE clients should resume the suspended application session. In another embodiment, the second Resumption Request message may comprise a UVE user ID, instead of a UVE user ID List, to indicate only the receiving UVE client. In yet another embodiment, if more than one suspended UVE application session is to be resumed, the second Resumption Request message may comprise a UVE session ID List, instead of a UVE session ID, to indicate a list of session identifications.

In response to the second Resumption Request message, the UVE clients A, B, and C resume the suspended application session (step S504). Specifically, the UVE clients A, B, and C may resume the suspended application session according to the second Resumption Request message. For example, the UVE clients A, B, and C may resume the suspended application session indicated by the UVE session ID in the second Resumption Request message, and the resumption is performed at the time indicated by the time for synchronization control in the second Resumption Request message.

After that, each of the UVE clients A, B, and C transmits a second Resumption Response message to the UVE server, in response to resuming the suspended application session (step S505). The second Resumption Response message may comprise a status and/or a cause, wherein the status indicates whether the session resumption is successful or failed, and the cause indicates the failure reason if the session resumption has failed, such as “incorrect session ID”, “incorrect UVE user ID”, “connection time-out”, etc. In another embodiment, the UVE client A may not transmit the second Resumption Response message to the UVE server, since it is the UVE client A who initiated the resumption procedure in the first place.

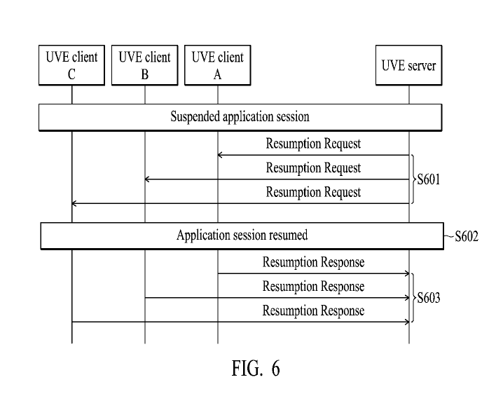

FIG. 6 is a message sequence chart illustrating a server-initiated session resumption according to an embodiment of the invention. In this embodiment, there are 3 UVE clients A, B, and C in a suspended application session with a UVE server, wherein the application session may be suspended as described above with respect to FIG. 4 or 5 or by other suspension mechanism, and the invention is not limited thereto. To begin, when the UVE server wishes to resume the suspended application session, it initiates a resumption procedure by transmitting a respective Resumption Request message to each of the UVE clients A, B, and C for resuming the suspended application session (step S601). The Resumption Request message may comprise any combination of a UVE user ID List, a UVE session ID, and a time for synchronization control, wherein the UVE user ID List indicates a list of identifications of the UVE clients intended for this resumption procedure, the UVE session ID indicates the identification of the session to be resumed, and the time for synchronization control indicates when the UVE clients should resume the suspended application session. In another embodiment, the Resumption Request message may comprise a UVE user ID, instead of a UVE user ID List, to indicate only the receiving UVE client. In yet another embodiment, if the UVE server wishes to resume more than one UVE application session, the Resumption Request message may comprise a UVE session ID List, instead of a UVE session ID, to indicate a list of session identifications.

In response to the Resumption Request message, the UVE clients A, B, and C resume the suspended application session (step S602). Specifically, the UVE clients A, B, and C may resume the suspended application session according to the Resumption Request message. For example, the UVE clients A, B, and C may resume the suspended application session indicated by the UVE session ID in the Resumption Request message, and the resumption is performed at the time indicated by the time for synchronization control in the Resumption Request message.

After that, each of the UVE clients A, B, and C transmits a Resumption

Response message to the UVE server, in response to resuming the suspended application session (step S603). The Resumption Response message may comprise a status and/or a cause, wherein the status indicates whether the session resumption is successful or failed, and the cause indicates the failure reason if the session resumption has failed, such as “incorrect session ID”, “incorrect UVE user ID”, “connection time-out”, etc.

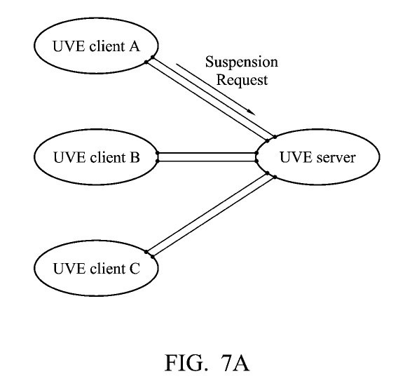

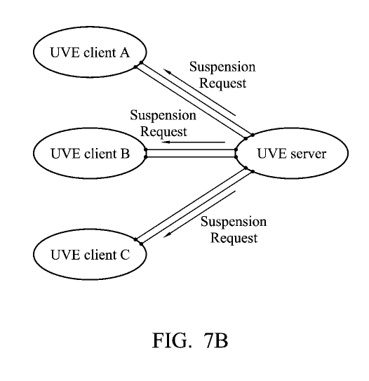

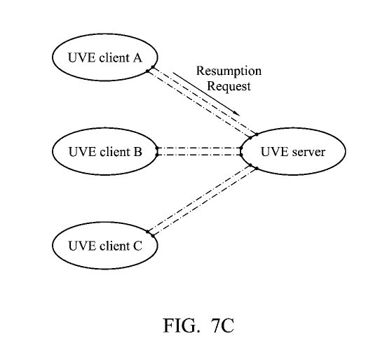

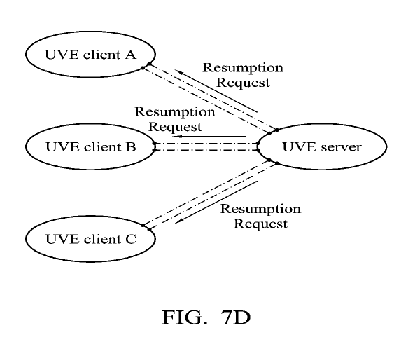

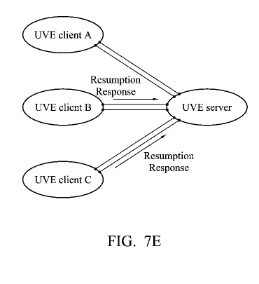

FIGS. 7A to 7E show a client-initiated session suspension and resumption according to an embodiment of the invention. In this embodiment, 3 UVE clients A, B, and C are connected to a UVE server for playing an online video game together. As shown in FIG. 7A, during the online video game, the UVE client A wishes to change the codec rate to enhance its connection quality, so it transmits a first Suspension Request message to the UVE server for suspending the application session of the online video game. After the UVE server implicitly acknowledges the first Suspension Request message, it transmits a second Suspension Request message to all UVE clients in the application session, as shown in FIG. 7B. When receiving the second Suspension Request message, each of the UVE clients suspends the application session. The detailed description of the first and second Suspension Request messages is similar to steps S302 and S304 in FIG. 3, and is omitted herein for brevity.

Later, when the codec rate is successfully negotiated and changed, the UVE client A transmits a first Resumption Request message to the UVE server for resuming the application session, as shown in FIG. 7C. After the UVE server implicitly acknowledges the first Resumption Request message, it transmits a second Resumption Request message to all UVE clients in the application session, as shown in FIG. 7D. When receiving the second Resumption Request message, each of the UVE clients resumes the application session. After the application session is resumed, each of the UVE clients B and C transmits a respective Resumption Response message to the UVE server to report the resumption status being successful. In this embodiment, the UVE client A does not need to transmit the Resumption Response message to the UVE server, due to the fact that it initiated the resumption procedure in the first place. In another embodiment, all UVE clients in the application session may each transmit a respective Resumption Response message to the UVE server to report the resumption status regardless of the resumption status being successful or failed. The detailed description of the first and second Resumption Request messages and the Resumption Response message is similar to steps S501, S503, and S505 in FIG. 5, and is omitted herein for brevity. Specifically, the ongoing application session is denoted with solid lines between each UVE client and the UVE server in FIGS. 7A, 7B, and 7E, and the suspended application session is denoted with dotted lines between each UVE client and the UVE server in FIGS. 7C and 7D.

Note that, although the UVE session control in FIGS. 7A to 7E is described with respect to the suspension procedure in FIG. 3 and the resumption procedure in FIG. 5, in other embodiments, any one of the suspension procedures in FIGS. 3 and 4 may be incorporated with any one of the resumption procedures in FIGS. 5 and 6, and the invention is not limited thereto.

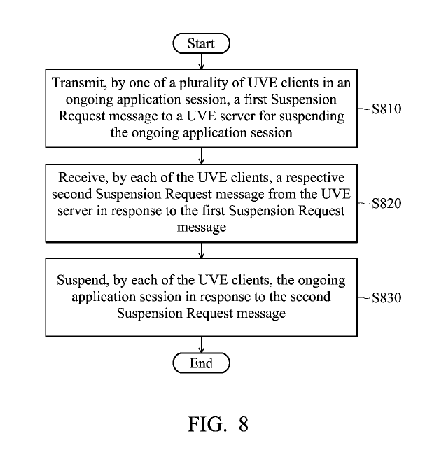

FIG. 8 is a flow chart illustrating the client-initiated session control method for UVE according to an embodiment of the invention. In this embodiment, it is assumed that there is a plurality of UVE clients in an ongoing application session with a UVE server, and a suspension procedure is initiated by one of the UVE clients. To begin, one of the UVE clients transmits a first Suspension Request message to a UVE server for suspending the ongoing application session (step S810). The first Suspension Request message may provide information concerning the suspension procedure. Specifically, the first Suspension Request message may indicate an identification of the one of the UVE clients, an identification of the ongoing application session, and a cause for suspending the ongoing application session. Subsequently, each of the UVE clients receives a respective second Suspension Request message from the UVE server in response to the first Suspension Request message (step S820). The second Suspension Request message may provide information which indicates identifications of the UVE clients or an identification of the respective UVE client, an identification of the ongoing application session, a time to suspend the ongoing application session, and a cause for suspending the ongoing application session. In response to the second Suspension Request message, each of the UVE clients suspends the ongoing application session (step S830), and the procedure ends.

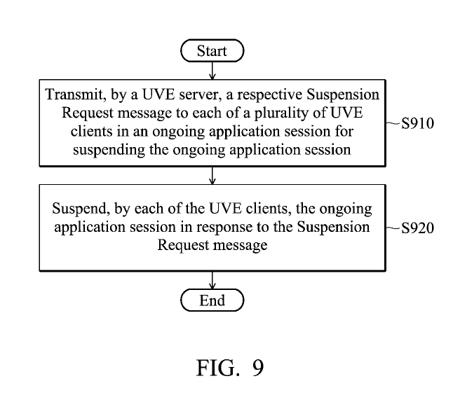

FIG. 9 is a flow chart illustrating the server-initiated session control method for UVE according to an embodiment of the invention. In this embodiment, it is assumed that there is a plurality of UVE clients in an ongoing application session with a UVE server, and a suspension procedure is initiated by the UVE server. To begin, the UVE server transmits a respective Suspension Request message to each of a plurality of UVE clients in an ongoing application session for suspending the ongoing application session (step S910). The Suspension Request message may provide information which indicates identifications of the UVE clients or an identification of the respective UVE client, an identification of the ongoing application session, a time to suspend the ongoing application session, and a cause for suspending the ongoing application session. Next, in response to the Suspension Request message, each of the UVE clients suspends the ongoing application session (step S920), and the procedure ends.

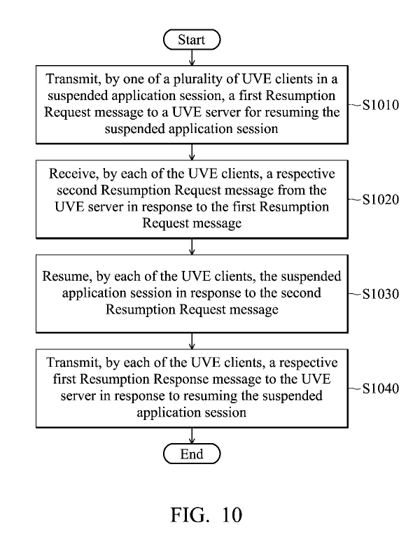

FIG. 10 is a flow chart illustrating the client-initiated session control method for UVE according to another embodiment of the invention. In this embodiment, it is assumed that there is a plurality of UVE clients in a suspended application session with a UVE server, and a resumption procedure is initiated by one of the UVE clients. To begin, one of the UVE clients transmits a first Resumption Request message to a UVE server for resuming the suspended application session (step S1010). The first Resumption Request message may provide information which indicates an identification of the one of the UVE clients, an identification of the suspended application session, and a cause for resuming the suspended application session. Next, each of the UVE clients receives a respective second Resumption Request message from the UVE server in response to the first Resumption Request message (step S1020). The second Resumption Request message may provide information which indicates identifications of the UVE clients or an identification of the respective UVE client, an identification of the suspended application session, a time to resume the suspended application session, and a cause for resuming the suspended application session. In response to the second Resumption Request message, each of the UVE clients resumes the suspended application session (step S1030). After that, each of the UVE clients transmits a respective first Resumption Response message to the UVE server in response to resuming the suspended application session (step S1040), and the procedure ends. Specifically, the first Resumption Response message may provide information which indicates the status of the session resumption, and a cause for session resumption failure.

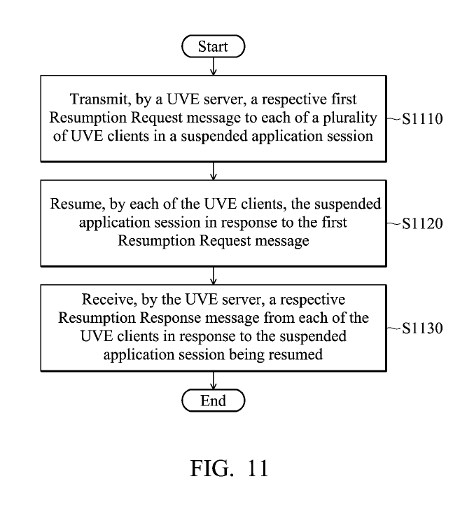

FIG. 11 is a flow chart illustrating the server-initiated session control method for UVE according to another embodiment of the invention. In this embodiment, it is assumed that there is a plurality of UVE clients in a suspended application session with a UVE server, and a resumption procedure is initiated by the UVE server. To begin, the UVE server transmits a respective Resumption Request message to each of the UVE clients (step S1110). The first Resumption Request message may provide information which indicates identifications of the UVE clients or an identification of the respective UVE client, an identification of the suspended application session, a time to resume the suspended application session, and a cause for resuming the suspended application session. In response to the Resumption Request message, each of the UVE clients resumes the suspended application session (step S1120). After that, the UVE server receives a respective Resumption Response message from each of the UVE clients in response to the suspended application session being resumed (step S1130), and the procedure ends. Specifically, the first Resumption Response message may provide information which indicates the status of the session resumption, and a cause for session resumption failure.

Note that the client-initiated and server-initiated session control methods for UVE in FIGS. 8-9 and 10-11 may be applied to any electronic device configured as a UVE client and UVE server, respectively. Specifically, the methods may be implemented with program code, which is enabled when loaded and executed by a general-purpose processor or an MCU of the electronic device.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A client-initiated session control method for Unified Virtual Experience (UVE), comprising:
transmitting, by one of a plurality of UVE clients in an ongoing application session, a first Suspension Request message to a UVE server for suspending the ongoing application session;
receiving, by each of the UVE clients, a respective second Suspension Request message from the UVE server in response to the first Suspension Request message; and
suspending, by each of the UVE clients, the ongoing application session in response to the second Suspension Request message.

2. The client-initiated session control method of claim 1, further comprising receiving, by the one of the UVE clients, a Suspension Request Acknowledgement message from the UVE server for acknowledging the reception of the first Suspension Request message, prior to receiving the second Suspension Request message.

3. The client-initiated session control method of claim 1, wherein the first Suspension Request message comprises at least one of an identification of the one of the UVE clients, an identification of the ongoing application session, and a cause for suspending the ongoing application session.

4. The client-initiated session control method of claim 1, wherein the second Suspension Request message comprises at least one of identifications of the UVE clients or an identification of the respective UVE client, an identification of the ongoing application session, a time to suspend the ongoing application session, and a cause for suspending the ongoing application session.

5. An electronic device, configured as one of a plurality of Unified Virtual Experience (UVE) clients in an ongoing application session with a UVE server, comprising:
first processor logic for transmitting a first Suspension Request message to the UVE server for suspending the ongoing application session;
second processor logic for receiving a respective second Suspension Request message for each of the UVE clients from the UVE server; and
third processor logic for suspending the ongoing application session in response to the second Suspension Request message.

6. The electronic device of claim 5, further comprising fourth processor logic for receiving a Suspension Request Acknowledgement message from the UVE server for acknowledging the reception of the first Suspension Request message, prior to receiving the second Suspension Request message.

7. The electronic device of claim 5, wherein the first Suspension Request message comprises at least one of an identification of the one of the UVE clients, an identification of the ongoing application session, and a cause for suspending the ongoing application session.

8. The electronic device of claim 5, wherein the second Suspension Request message comprises at least one of identifications of the UVE clients or an identification of the respective UVE client, an identification of the ongoing application session, a time to suspend the ongoing application session, and a cause for suspending the ongoing application session.

9. A server-initiated session control method for Unified Virtual Experience (UVE), comprising:
transmitting, by a UVE server, a respective Suspension Request message to each of a plurality of UVE clients in an ongoing application session for suspending the ongoing application session; and
suspending, by each of the UVE clients, the ongoing application session in response to the Suspension Request message.

10. The server-initiated session control method of claim 9, wherein the Suspension Request message comprises at least one of identifications of the UVE clients or an identification of the respective UVE client, an identification of the ongoing application session, a time to suspend the ongoing application session, and a cause for suspending the ongoing application session.

11. An electronic device, configured as a Unified Virtual Experience (UVE) server, comprising:
first processor logic for transmitting a respective Suspension Request message to each of a plurality of UVE clients in an ongoing application session for suspending the ongoing application session,
so that each of the UVE clients suspends the ongoing application session in response to the Suspension Request message.

12. The electronic device of claim 11, wherein the Suspension Request message comprises at least one of identifications of the UVE clients or an identification of the respective UVE client, an identification of the ongoing application session, a time to suspend the ongoing application session, and a cause for suspending the ongoing application session.

13. A client-initiated session control method for Unified Virtual Experience (UVE), comprising:
transmitting, by one of a plurality of UVE clients in a suspended application session, a first Resumption Request message to a UVE server for resuming the suspended application session;
receiving, by each of the UVE clients, a respective second Resumption Request message from the UVE server in response to the first Resumption Request message;
resuming, by each of the UVE clients, the suspended application session in response to the second Resumption Request message; and
transmitting, by each of the UVE clients, a respective first Resumption Response message to the UVE server in response to resuming the suspended application session.

14. The client-initiated session control method of claim 13, wherein the first Resumption Request message comprises at least one of an identification of the one of the UVE clients, an identification of the suspended application session, and a cause for resuming the suspended application session.

15. The client-initiated session control method of claim 13, further comprising receiving, by the one of the UVE clients, a second Resumption Response message from the UVE server for acknowledging the reception of the first Resumption Request message, prior to receiving the second Resumption Request message.

16. The client-initiated session control method of claim 13, wherein the second Resumption Request message comprises at least one of identifications of the UVE clients or an identification of the respective UVE client, an identification of the suspended application session, a time to resume the suspended application session, and a cause for resuming the suspended application session.

17. The client-initiated session control method of claim 13, wherein the first Resumption Response message indicates a status of the session resumption, and a cause for session resumption failure.

18. An electronic device, configured as one of a plurality of Unified Virtual Experience (UVE) clients in a suspended application session with a UVE server, comprising:
first processor logic for transmitting a first Resumption Request message to the UVE server for resuming the suspended application session;
second processor logic for receiving a respective second Resumption Request message for each of UVE clients from the UVE server;
third processor logic for resuming the suspended application session in response to the second Resumption Request message; and
fourth processor logic for transmitting a first Resumption Response message to the UVE server in response to resuming the suspended application session.

19. The electronic device of claim 18, wherein the first Resumption Request message comprises at least one of an identification of the one of the UVE clients, an identification of the suspended application session, and a cause for resuming the suspended application session.

20. The electronic device of claim 18, further comprising fifth processor logic for receiving a second Resumption Response message from the UVE server for acknowledging the reception of the first Resumption Request message, prior to receiving the second Resumption Request message.

21. The electronic device of claim 18, wherein the second Resumption Request message comprises at least one of identifications of the UVE clients or an identification of the respective UVE client, an identification of the suspended application session, a time to resume the suspended application session, and a cause for resuming the suspended application session.

22. The electronic device of claim 18, wherein the first Resumption Response message indicates a status of the session resumption, and a cause for session resumption failure.

23. A server-initiated session control method for Unified Virtual Experience (UVE), further comprising:
transmitting, by a UVE server, a respective Resumption Request message to each of a plurality of UVE clients in a suspended application session;
resuming, by each of the UVE clients, the suspended application session in response to the Resumption Request message; and
receiving, by the UVE server, a respective Resumption Response message from each of the UVE clients in response to the suspended application session being resumed.

24. The server-initiated session control method of claim 23, wherein the Resumption Request message comprises at least one of identifications of the UVE clients or an identification of the respective UVE client, an identification of the suspended application session, a time to resume the suspended application session, and a cause for resuming the suspended application session.

25. The server-initiated session control method of claim 23, wherein the Resumption Response message indicates a status of the session resumption, and a cause for session resumption failure.

26. An electronic device, configured as a Unified Virtual Experience (UVE) server, comprising:
first processor logic for transmitting a respective Resumption Request message to each of a plurality of UVE clients in a suspended application session, so that each of the UVE clients resumes the suspended application session; and
second processor logic for receiving a respective Resumption Response message from each of the UVE clients.

27. The electronic device of claim 26, wherein the Resumption Request message comprises at least one of identifications of the UVE clients or an identification of the respective UVE client, an identification of the suspended application session, a time to resume the suspended application session, and a cause for resuming the suspended application session.

28. The electronic device of claim 26, wherein the Resumption Response message indicates a status of the session resumption, and a cause for session resumption failure.
